(19) United States
(12) Patent Application Publication
(10) Pub. No.: US 2014/0129215 A1
(43) Pub. Date: May 8, 2014

(54) ELECTRONIC DEVICE AND METHOD FOR ESTIMATING QUALITY OF SPEECH SIGNAL

(71) Applicant: Samsung Electronics Co., Ltd., Suwon-si (KR)

(72) Inventors: Nak-Jin CHOI, Suwon-si (KR); Byeong-Jun KIM, Suwon-si (KR); Ju-Hee CHANG, Seongnam-si (KR); Brian C.J. MOORE, Cambridge (GB)

(73) Assignee: Samsung Electronics Co., Ltd., Suwon-si (KR)

(21) Appl. No.: 14/071,084

(22) Filed: Nov. 4, 2013

Related U.S. Application Data
(60) Provisional application No. 61/721,760, filed on Nov. 2, 2012.

(51) Int. Cl. G10L 19/012

(52) U.S. Cl. CPC G10L 19/012
USPC 704/226

(57) ABSTRACT

An electronic device and a method for measuring quality of a voice signal are provided. The method includes generating a mask of an echo signal and a mask of a speech signal by comparing the echo signal and the speech signal included in an input sound with respective thresholds, calculating an estimation of the echo signal and an estimation of the speech signal, and measuring quality of the input speech signal by using each of the calculated estimation of the echo signal and the calculated estimation of the speech signal.

### CROSS-REFERENCE TO RELATED APPLICATION(S)

This application claims the benefit under 35 U.S.C. §119(a) of a U.S. Provisional application filed on Nov. 2, 2012 in the U.S. Patent and Trademark Office and assigned Ser. No. 61/721,760, the entire disclosure of which is hereby incorporated by reference.

### TECHNICAL FIELD

The present disclosure relates to an electronic device and a method for measuring quality of a voice signal.

### BACKGROUND

Currently, various services and additional functions provided by an electronic device are gradually expanded. In order to increase an effective value of the electronic device and to meet various demands of users, various applications executable by the electronic device have been developed and the electronic devices have provided various multimedia functions.

Accordingly, standards of user's demands of resolution of a screen or camera, speech output through a speaker or earphone, and quality of music have gradually risen, and a method of detecting the standard of sound quality felt by the user and evaluating sound quality to guarantee the quality has become important.

In general, when the users make a voice call or a video call by using the electronic device in a speaker phone mode, the users feel inconvenienced because of call quality deterioration due to echo, conversation voice disconnection, or conversation voice attenuation. The echo corresponds to a sound which a user hears through a speaker of the electronic device while a voice of the user output through a speaker of the electronic device of a counterpart user is input back into a microphone of the electronic device of the counterpart user due to a limitation in a physical structure of the electronic device. However, because a small electronic device cannot have a speaker and a microphone which are completely separated from each other, the electronic device invariably has an echo in a case in which an output sound is loud. Accordingly, the research to improve call quality by predicting sound quality of an echo and speech from a speech signal including an echo component is in progress.

ITU-T P.800 provides a general method of subjectively evaluating speech quality for call quality as a part of the research, ITU-T P.835 provides a method of subjectively evaluating speech quality for removing a noise, and ITU-T P.831 provides a method of subjectively evaluating speech quality for performance of an echo canceller. Further, ITU-T P.563, P.862, and P.863 provide a method of subjectively evaluating speech quality for speech. In addition, various researches to evaluate and predict a linear/nonlinear distortion degree of speech quality due to several factors are in progress.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. As described above, in the related art, an echo phenomenon may variously appear according to an internal structure of a chip set applied to the electronic device, a type of an algorithm, a structure of a mechanism, and output volume. In this case, when a subjective evaluation is performed, a result may vary depending on an evaluator. Further, performing the subjective evaluation of the echo performance may cause time and human resource consumption, and accurately analyzing the echo phenomenon may be difficult. In addition, currently used quantitative evaluation items for the echo may not reflect speech which the user hears.

Accordingly, evaluating sound quality in a call state by accurately analyzing the echo phenomenon and optimizing the sound quality based on the evaluation is required.

In accordance with an aspect of the present disclosure, an electronic device and a method for measuring quality of a speech signal is provided.

In accordance with an aspect of the present disclosure, a method of measuring quality of a speech signal is provided. The method includes generating a mask of an echo signal and a mask of a speech signal by comparing the echo signal and the speech signal included in an input sound with respective thresholds, calculating an estimation of the echo signal and an estimation of the speech signal, and measuring quality of the input speech signal by using each of the calculated estimation of the echo signal and the calculated estimation of the speech signal.

In accordance with an aspect of the present disclosure, the input sound may be separated into the echo signal and the speech signal by using the generated masks of the echo signal and the speech signal.

In accordance with an aspect of the present disclosure, the generating of the mask may include performing a gammatone filtering for the input speech signal, dividing the gammatone filtered speech signal into a plurality of frames to configure a matrix, multiplying the configured matrix and the divided plurality of frames, performing a Fast Fourier Transform (TTF) on a result of the multiplication between the configured matrix and the divided plurality of frames, and generating the mask of the echo signal and the mask of the speech signal by comparing the transformed value with each of the thresholds.

In accordance with an aspect of the present disclosure, the method may further include passing the echo signal through the generated mask of the echo signal, passing the speech signal through the generated mask of the speech signal, and performing an Inverse Fast Fourier Transform (IFFT) for each of the signals which have passed through the mask of the echo signal and the mask of the speech signal.

In accordance with an aspect of the present disclosure, the generating of the mask may include determining the input sound as the speech signal when an intensity of the input sound is equal to or larger than a first threshold, and determining the input sound as a non-speech signal when the intensity of the input sound is smaller than the first threshold.

In accordance with an aspect of the present disclosure, the generating of the mask may include determining the input sound as a non-echo signal when an intensity of the input sound is equal to or larger than a second threshold, and determining the input sound as the echo signal when the intensity of the input sound is smaller than the second threshold.

In accordance with another aspect of the present disclosure, an electronic device measuring quality of a speech signal is provided. The electronic device includes a microphone that receives a sound, a signal separator that compares an echo signal and a speech signal included in the received sound with respective thresholds to generate a mask of the echo signal and a mask of the speech signal, calculates an estimation of the echo signal and an estimation of the speech signal, and measures quality of the received speech signal by using each of the calculated estimation of the echo signal and the calculated estimation of the speech signal.

In accordance with an aspect of the present disclosure, the signal separator may separate the received speech signal into an echo signal and a speech signal by using the generated mask of the echo signal and the generated mask of the speech signal.

In accordance with an aspect of the present disclosure, the signal separator may perform a gammatone filtering for the received speech signal, divide the gammatone filtered speech signal into a plurality of frames to configure a matrix, multiplies the configured matrix and the divided plurality of frames, perform a Fast Fourier Transform (FFT) on a result of the multiplication between the configured matrix and the divided plurality of frames, and compare the transformed value with the respective thresholds, so as to generate the mask of the echo signal and the mask of the speech signal.

In accordance with an aspect of the present disclosure, the signal separator may pass the echo signal and the speech signal through the generated mask of the echo signal and the generated mask of the speech signal, respectively, and perform an IFFT for each of the signals having passed the masks.

In accordance with an aspect of the present disclosure, the generated mask of the speech signal may set a window to “1” when an intensity of the received sound is equal to or larger than a first threshold, and set the window to “0” when the intensity of the received sound is smaller than the first threshold.

In accordance with an aspect of the present disclosure, the generated mask of the echo signal may set a window to “0” when an intensity of the received sound is equal to or larger than a second threshold, and set the window to “1” when the intensity of the received sound is smaller than the second threshold.

In accordance with an aspect of the present disclosure, the estimation of the speech signal may be calculated through a correlation between signals generated by passing the sound and the speech signal through the mask of the speech signal.

In accordance with an aspect of the present disclosure, the estimation of the echo signal is calculated through an energy of an echo component remaining after passing through an echo canceller.

In accordance with another aspect of the present disclosure, it is possible to separate a sound input during a call into a speech signal and an echo signal and measure quality of the separated speech signal to optimize a speech quality parameter, thereby improving call quality and allowing the user to receive a speech signal which is not mixed with the echo signal.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example of an electronic device according to various embodiments of the present disclosure;

FIG. 2 is a block diagram illustrating an apparatus that measures quality of a speech signal according to an embodiment of the present disclosure;

FIG. 3 illustrates an internal configuration of a signal separator according to an embodiment of the present disclosure;

FIG. 4A illustrates an example of a threshold and a mask applied to a speech signal according to an embodiment of the present disclosure;

FIG. 4B illustrates an example of a threshold and a mask applied to an echo signal according to an embodiment of the present disclosure; and

FIG. 5 is a flowchart illustrating a method of measuring quality of a speech signal according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While terms including ordinal numbers, such as “first” and “second,” and the like, may be used to describe various components, such components are not limited by the above terms. The terms are used merely for the purpose to distinguish an element from the other elements. For example, a first element could be termed a second element, and similarly, a second element could be also termed a first element without departing from the scope of the present disclosure. As used herein, the term “and/or” includes any and all combinations of one or more of the associated listed items.

The terms used herein are merely used to describe specific embodiments, and are not intended to limit the present disclosure. As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an operation principle for various embodiments of the present disclosure will be described in detail with reference to the accompanying drawings. In the following description of various embodiments of the present disclosure, a detailed description of known functions and configurations incorporated herein will be omitted when such a description may make the subject matter of the present disclosure rather unclear. The terms which will be described below are terms defined in consideration of the functions in the present disclosure, and may be different according to users, intentions of the users, or customs. Therefore, definition of various terms will be made based on the overall contents of this specification.

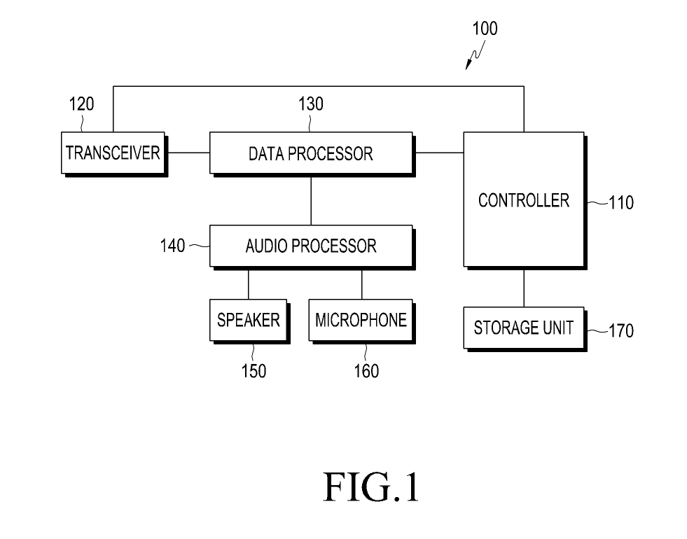

FIG. 1 illustrates an example of an electronic device according to various embodiments of the present disclosure. For example, FIG. 1 is a block diagram illustrating an electronic device according to various embodiments of the present disclosure.

Referring to FIG. 1, the electronic device 100 according to various embodiments of the present disclosure includes a controller 110, a transceiver 120, a data processor 130, an audio processor 140, a speaker 150, a microphone 160, and a storage unit 170.

According to various embodiments of the present disclosure, the electronic device 100 may be a mobile terminal capable of performing data transmission/reception and a voice/video call. The electronic device 100 may include one or more screens, and each of the screens may display one or more pages. The electronic device 100 may include a smart phone, a tablet Personal Computer (PC), a 3D-TeleVision (TV), a smart TV, a Light Emitting Diode (LED) TV, and Liquid Crystal Display (LCD) TV, the like, and also may include all devices which can communicate with a peripheral device or another terminal located at a remote place. Further, the one or more screens included in the electronic device 100 may receive an input by at least one of a touch and a hovering.

The transceiver 120 of the electronic device 100 includes a radio frequency circuit unit (not shown) that performs a communication function of the electronic device 100. The transceiver 120 may include a radio frequency transmitter for up-converting and amplifying a frequency of a transmitted signal and a radio frequency receiver for low noise-amplifying a received signal and down-converting a frequency. The data processor 130 may include a transmitter for encoding and modulating the transmitted signal and a receiver for decoding and demodulates the received signal. The audio processor 140 may perform a function of reproducing an audio signal decoded and output from the data processor 130 to output the audio signal through the speaker 150 or processing a signal input through the microphone 160 to transmit the signal to the data processor 130. The audio processor 130 may remove an echo signal included in a speech signal input through the microphone 160. The echo signal corresponds to a signal output from the speaker 150 and then input into the microphone 160. Accordingly, a signal input into the microphone 160 may include the echo signal as well as a speech signal of the user. The storage unit 170 may include a program memory and data memories, and the program memory stores a program for controlling a general operation of the electronic device 100. The controller 110 may perform a general control of the electronic device 100, and perform an operation executed by at least one of the audio processor 140 and the data processor 130.

Further, the controller 110 may include a Central Processing Unit (CPU), a Read Only Memory (ROM) storing a control program for controlling the electronic device 100, and a Random Access Memory (RAM) used as a storage area for storing a signal or data input from the outside of the electronic device 100 or for work performed in the electronic device 100. The CPU may include a various number of cores. For example, the CPU may include a single core, a dual core, a triple core, or a quadruple core.

According to various embodiments of the present disclosure, the controller 110 compares an echo signal and a speech signal included in the input sound with respective thresholds to generate a mask of the echo signal and a mask of the speech signal, calculates an estimation of the echo signal and an estimation of the speech signal, and measures quality of the speech signal of the input sound by using each of the calculated estimations. Further, the controller 110 may separate the input speech signal into an echo signal and a speech signal by using the generated masks of the echo signal and the speech signal.

The controller 110 may perform gammatone filtering for the input speech signal, divide the gammatone filtered speech signal into a plurality of frames to configure a matrix, multiply the configured matrix and the divided frames, perform a Fast Fourier Transform (FFT) for a result of the multiplication, and compare the transformed value with each threshold, so as to generate a mask of the echo signal and a mask of the speech signal.

The controller 110 may pass the echo signal through the generated mask of the echo signal and the speech signal through the generated mask of the speech signal, and perform an Inverse Fast Fourier Transform (IFFT) for each of the signals having passed through the mask of the echo signal and the mask of the speech signal.

According to various embodiments of the present disclosure, when an intensity of the input sound is equal to or larger than a first threshold, the controller 110 may determine the input sound as the speech signal. According to various embodiments of the present disclosure, when the intensity of the input sound is smaller than the first threshold, the controller 110 may determine the input sound as a non-speech signal. According to various embodiments of the present disclosure, when the intensity of the input sound is equal to or larger than a second threshold, the controller 110 may determine the input sound as a non-echo signal. According to various embodiments of the present disclosure, when the intensity of the input sound is smaller than the second threshold, the controller 110 may determine the input sound as the echo signal.

According to various embodiments of the present disclosure, an estimation of the echo signal may be calculated through an energy of an echo component remaining passing through an echo canceller, and an estimation of the speech signal may be calculated through a correlation between signals after each of the sound and the speech signal passes through the mask of the speech signal.

According to various embodiments of the present disclosure, the electronic device 100 may include a microphone that receives a sound, a signal separator that compares an echo signal and a speech signal included in the input sound with respective thresholds to generate a mask of the echo signal and a mask of the speech signal, and a performance evaluator that calculates an estimation of the echo signal and an estimation of the speech signal and measures quality of the input speech signal by using each of the calculated estimations.

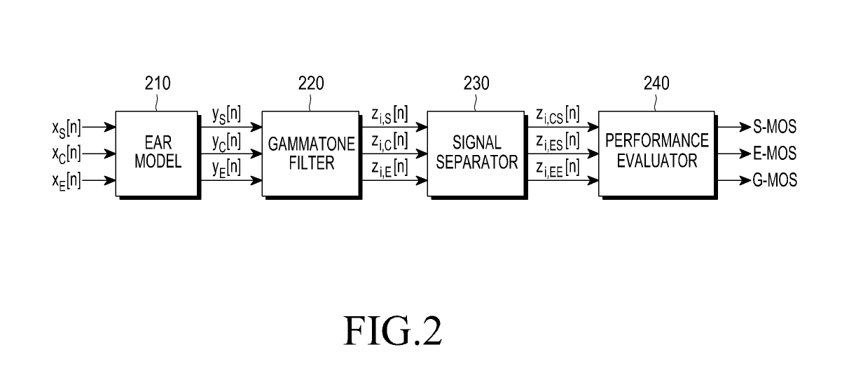

The signal separator (e.g., such as the signal separator 230 illustrated in FIG. 2 and described below) may separate the input speech signal into an echo signal and a speech signal by using the generated mask of the echo signal and mask of the speech signal, perform gammatone filtering for the input speech signal, divide the gammatone filtered speech signal into a plurality of frames to configure a matrix, multiply the configured matrix and the divided frames, perform a FFT for a result of the multiplication, and compare the transformed value with each threshold, so as to generate a mask of the echo signal and a mask of the speech signal. In the generated mask of the speech signal, a window is set to “1” when an intensity of the input sound is equal to or larger than a first threshold, and the window is set to “0” when the intensity of the input sound is smaller than the first threshold. Further, in the generated mask of the echo signal, a window is set to “0” when the intensity of the input sound is equal to or larger than a second threshold, and the window is set to “1” when the intensity of the input sound is smaller than the second threshold. In addition, the signal separator (e.g., such as the signal separator 230 as described below) may pass the echo signal and the speech signal through the generated mask of the echo signal and the generated mask of the speech signal, respectively, and perform an IFFT for each of the signals having passed through the masks. The estimation of the speech signal may be calculated through a correlation between the signals generated by passing the sound and the speech signal through the mask of the speech mask. The estimation of the echo signal may be calculated through energy of an echo component which has been left after passing through an echo canceller.

FIG. 2 is a block diagram illustrating an apparatus that measures quality of a speech signal according to an embodiment of the present disclosure.

Referring to FIG. 2, the apparatus for measuring quality of the speech signal includes an ear model 210, a gammatone filter 220, a signal separator 230, and a performance evaluator 240. According to various embodiments of the present disclosure, the apparatus for measuring quality of the speech signal may be included in the audio processor 140 or the controller 110.

The signal input into the ear model 210 corresponds to the signal which has passed through the echo canceller (not shown) included in the electronic device 100. The input signal includes an original speech signal (original source speech) xS[n], a clean speech signal (clean speech) xC[n] to which no echo signal is added, and a signal xE[n] in which the speech signal and the echo signal which have passed through the echo canceller are mixed. The ear model 210 refers to a filter simulating an influence when a signal is transmitted through an outer ear and a middle ear, and a transfer function h_{oM}[n] of the ear model 210 is as follows.

h_{OM}[n], 0≦n≦N_{OM}−1

In the transfer function, OM denotes the outer and middle ears, and n denotes a corresponding signal. The ear model 210 controls α to minimize an echo component RGT(i)(S+E, EC)−αRGT(i)(CS) of an i^{th} gammatone filter output GT(i). Here, i denotes an i^{th} filter, and filters are arranged at intervals of 1-ERBN. ERB denotes an equivalent rectangular bandwidth. A response to GT(i) with respect to signal k is defined as RGT(i)k. Further, a denotes a scaling factor considering a change in a size of the signal having passed through the echo canceller. A value when RGT(i)(S+E, EC)−αRGT(i)(CS) is minimized is defined as GT(i)(Eresid), and the value refers to an estimation of the echo component of the output GT(i). RGT(i)(CS)+βGT(i)(Eresid) denotes a clean signal to which the echo component is added. Here, β is a variable for controlling a prediction result of the model to match with a subjective evaluation result. If β is small, then an echo cancellation system has an excellent performance.

The signals (e.g., xS[n], xC[n], and xE[n]) having passed through the ear model 210 are indicated by yS[n], yC[n], and yE[n], respectively. Each of the signals having passed through the ear model 210 is input into the gammatone filter 220. An array of the gammatone filter for simulating an ear filter by the gammatone filter 220 corresponds to gᵢ(·) which is as follows.

gᵢ(·), 1≦i≦N_{ERB}

ERB denotes an equivalent rectangular bandwidth.

z_{i,S}[n] output from the gammatone filter 220 denotes an i^{th} gammatone filter output of the original speech signal (original source speech) and is expressed by Equation (1) below.

z_{i,S}[n]=gᵢ(h_{OM}[n]*x_{S}[n]), 1≦i≦N_{ERB}, 0≦n≦L₁−1 Equation (1)

z_{i,C}[n] output from the gammatone filter 220 denotes an i^{th} gammatone filter output of the clean speech signal (clean speech) and is expressed by Equation (2) below.

z_{i,C}[n]=gᵢ(h_{OM}[n]*x_{C}[n]), 1≦i≦N_{ERB}, 0≦n≦L₁−1 Equation (2)

z_{i,E}[n] output from the gammatone filter 220 denotes an i^{th} gammatone filter output of the signal (speech plus echo) in which the speech signal and the echo signal which have passed through the echo canceller are mixed, and is expressed by Equation (3) below.

z_{i,E}[n]=gᵢ(h_{OM}[n]*x_{E}[n]), 1≦i≦N_{ERB}, 0≦n≦L₁−1 Equation (3)

The signal separator 230 receives z_{i,S}[n], z_{i,C}[n], and z_{i,E}[n] output from the gammatone filter 220 and generates a mask to more accurately predict sound quality of a signal which the user actually hears, so as to separate the speech signal and the echo signal.

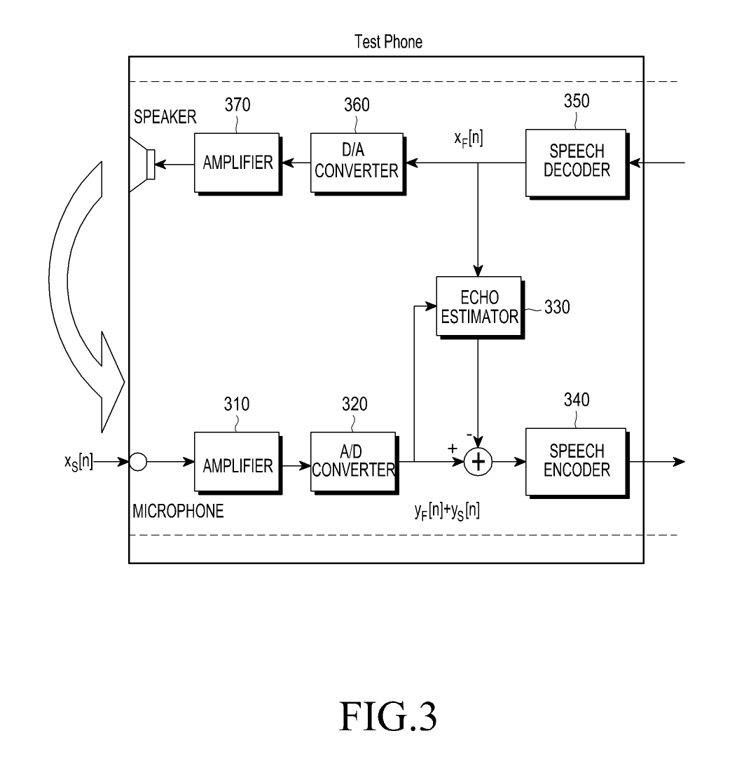

The signal separator 230 estimates speech in z_{i,C}[n] to generate z_{i,CS}[n] and estimates speech in z_{i,C}[n] to generate z_{i,ES}[n]. The signal separator 230 may have a signal separation algorithm separating the signal into speech and an echo therein. The signal separator 230 generates a speech signal mask (speech mask) and an echo signal mask (echo mask) by applying a hard decision scheme to the original signal (near-end speech) and passes a signal to be evaluated through the generated masks, so as to separate the signal into the speech and the echo. Speech Mean Opinion Score (S-MOS) and Echo Mean Opinion Score (E-MOS) are calculated from the separated signals. Hereinafter, calculation of the S-MOS and E-MOS will be described in more detail with reference to FIG. 3.

FIG. 3 illustrates an internal configuration of the signal separator according to an embodiment of the present disclosure.

Referring to FIG. 3, the signal separator 230 includes an amplifier 310 for amplifying a near-end speaker's speech signal input into the microphone 160, an Analog-to-Digital (A/D) converter 320 for converting the amplified speech signal to a digital signal, an echo estimator 330 for estimating an echo signal from the converted echo signal, a voice decoder 350 for decoding a far-end speaker's speech signal, a Digital-to-Analog (D/A) converter 360 for converting the decoded speech signal to an analog signal, an amplifier 370 for amplifying the converted analog signal, and a voice encoder 340 for encoding a signal in which the signal output from the A/D converter 320 and the signal output from the echo estimator 330 are added.

The signal separator 230 generates the speech signal mask (speech mask) and the echo signal mask (echo mask) by using xₛ[n] and passes x_{X}[n] and x_{E}[n] through the generated masks, so as to separate the signal into the speech and the echo.

x_{F}[n] refers to the far-end speaker's speech signal, x_{S}[n] refers to the near-end speaker's speech signal input into the microphone, and y_{F}[n]+y_{S}[n] refers to the signal generated after x_{F}[n] and x_{S}[n] output from the speaker 150 are input into the microphone 160 via an acoustic path and then passes through the echo canceller. The signal may be a signal in which the echo signal and a distorted speech are mixed.

According to various embodiments of the present disclosure, when an intensity of the input signal is equal to or larger than a threshold δS, the signal separator 230 determines the input signal as the speech signal and sets a window of the mask to “1”. According to various embodiments of the present disclosure, when the intensity of the input signal is smaller than the threshold δS, the signal separator 230 determines the input signal as a non-speech signal and sets the window of the mask to “0”, so as to generate a speech signal mask filter (speech mask filter). Further, according to various embodiments of the present disclosure, when the intensity of the input echo signal is equal to or larger than a threshold δE, the signal separator 230 determines the input signal as a non-echo signal and sets the window of the mask to “0”. According to various embodiments of the present disclosure, when the intensity of the input echo signal is smaller than the threshold δE, the signal separator 230 determines the input signal as the echo signal and sets the window of the mask to “1”, so as to generate an echo signal mask filter (echo mask filter).

According to various embodiments of the present disclosure, each of the thresholds δS and δE may be changed to optimize the performance.

Hereinafter, a process of generating the mask filters will be described.

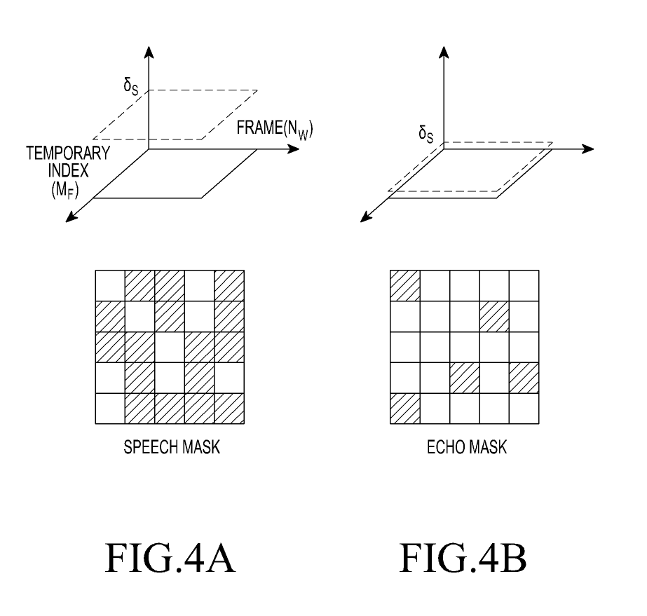

Equation (1) above is calculated by passing x_{S}[n] through the ear model 210 and the gammatone filter 220. Further, z_{i,S}[n] is divided into Mf frames by using windows and then reconfigured as a (NW×Mf) matrix as illustrated in FIG. 4A. A window size is NW=2048, an overlap rate is r=0.25, a new window sample is NS=rNW=512, and the number of frames is Mf=[LI/NS]+1. z_{i,S} input into the signal separator 230 may be defined as a vector including z_{i,S}[n] (n is a value from 0 to L1−1) as shown in Equation (4) below.

$$\\ {N}_{S} = {rN}_{W} \\ {M}_{f} = ⌈ ( {L}_{1} + 2 {N}_{W} ) \text{/} {N}_{S} ⌉ \\ {z}_{i , S 1} = [ \begin{matrix}{0}_{{N}_{w} \times 1} \\ \text{?} \\ {0}_{( ( {M}_{f} - 1 ) {N}_{s} - \text{?} - {N}_{W} ) \times 1} \\ {0}_{{N}_{W} \times 1}\end{matrix} ] \text{:} ( ( {M}_{f} - 1 ) {N}_{S} + {N}_{W} ) \times 1 \\ \text{?} [ n , m ] = {z}_{i , S 1} [ {mN}_{S} + n ] 1 \leq i \leq {N}_{ERB} , 0 \leq m \leq {M}_{f} - 1 , 0 \leq n \leq {N}_{W} - 1 \\ \text{?} \text{indicates text missing or illegible when filed} \qquad Equation ( 4 )$$

In Equation (4), NW denotes a window length, r denotes a new sample rate within a new frame, Mf denotes the number of frames, and Ns denotes the number of new samples within a new frame. z_{i,S1} and matrices z_{i,S2} and z_{i,S,W} may be derived from z_{i,S} through frame-based signal processing.

z_{i,S2} may be indicated by a matrix as shown in Equation (5) below.

$$\text{?} = [ \begin{matrix}\text{?} [ 0 ] & \text{?} [ {N}_{S} ] & … & \text{?} [ ( {M}_{f} - 1 ) {N}_{S} ] \\ \text{?} [ 1 ] & \text{?} [ {N}_{S} + 1 ] & … & \text{?} [ ( {M}_{f} - 1 ) {N}_{S} + 1 ] \\ ⋮ & ⋮ & ⋱ & ⋮ \\ \text{?} [ {N}_{W} - 1 ] & \text{?} [ {N}_{S} + {N}_{W} - 1 ] & … & \text{?} [ ( {M}_{f} - 1 ) {N}_{S} + {N}_{W} - 1 ]\end{matrix} ] \text{:} {N}_{W} \times {M}_{f} \\ \text{?} \text{indicates text missing or illegible when filed} \qquad Equation ( 5 )$$

wₐ may be indicated by a matrix for analyzing windows as shown in Equation (6) below, and wₛ may be indicated by a matrix for integrating windows as shown in Equation (7) below.

$$\begin{matrix}{w}_{a} = [ \begin{matrix}{w}_{a} [ 0 ] & … & {w}_{a} [ 0 ] \\ ⋮ & ⋱ & ⋮ \\ {w}_{a} [ {N}_{W} - 1 ] & … & {w}_{a} [ {N}_{W} - 1 ]\end{matrix} ] \text{:} {N}_{W} \times {M}_{f} & Equation ( 6 ) \\ {w}_{s} = [ \begin{matrix}{w}_{s} [ 0 ] & … & {w}_{s} [ 0 ] \\ ⋮ & ⋱ & ⋮ \\ {w}_{s} [ {N}_{W} - 1 ] & … & {w}_{s} [ {N}_{W} - 1 ]\end{matrix} ] \text{:} {N}_{W} \times {M}_{f} \\ {z}_{i , S , W} = {W}_{a} . \times {z}_{i , S 2} & Equation ( 7 )\end{matrix}$$

x denotes an element unit matrix result.

wₐ and wₛ should satisfy Equation (8) below for perfect reconstruction.

$${\sum }_{m = - ∞}^{∞} {w}_{a} [ n - {mN}_{S} ] \text{?} [ n - {mN}_{S} ] = 1 \\ where \\ - ∞ \leq m \leq + ∞ , 0 \leq n \leq {N}_{W} - 1 \\ \text{?} \text{indicates text missing or illegible when filed} \qquad Equation ( 8 )$$

The speech signal mask filter H_{i,S}[k,m] and the echo signal mask filter H_{i,E}[k,m] may be derived from the i^{th} gammatone filter output of the original speech signal through Equation (9) below. In Equation (9), Z_{i,S,W} is the FFT of z_{i,S,W}.

Z_{i,S,W}=FFT(z_{i,S,W}) Equation (9)

The speech signal mask filter H_{i,S}[k,m] and the echo signal mask filter H_{i,E}[k,m] are generated by comparing |Z_{i,S,W}[k,m]| (1≦i≦N_{ERB}) with the speech signal threshold δS and the echo signal threshold δE.

Through the above described process, the signal (speech plus echo) in which the speech signal and the echo signal are mixed is separated into the speech signal and the echo signal by the filter mask of the signal separator 230.

Further, z_{i,C} input into the signal separator 230 is defined as a vector including z_{i,C}[n] (n is a value from 0 to L1−1), and z_{i,E} is defined as a vector including z_{i,E}[n] (n is a value from 0 to L1−1). Through the frame-based signal processing, vector z_{i,C1} and matrices z_{i,C2} and z_{i,C,W} are derived from z_{i,C} as shown in Equation (10) below, and vector z_{i,E1} and matrices z_{i,E2} and z_{i,E,W} are derived from z_{i,E} as shown in Equation (11) below.

$$\begin{matrix}\text{?} = [ \begin{matrix}{0}_{{N}_{W} \times 1} \\ {z}_{i , C} \\ {0}_{( ( {M}_{f} - 1 ) {N}_{S} - {L}_{1} - {N}_{w} ) \times 1} \\ {0}_{{N}_{W} \times 1}\end{matrix} ] \text{:} ( ( {M}_{f} - 1 ) {N}_{S} + {N}_{W} ) \times 1 \\ {z}_{i , C 2} [ n , m ] = {z}_{i , C 1} [ {mN}_{s} + n ] 1 \leq i \leq {N}_{ERB} , \\ 0 \leq m \leq {M}_{f} - 1 , 0 \leq n \leq {N}_{W} - 1 \\ \text{?} = [ \begin{matrix}\text{?} [ 0 ] & \text{?} [ {N}_{S} ] & … & \text{?} [ ( {M}_{f} - 1 ) {N}_{S} ] \\ \text{?} [ 1 ] & \text{?} [ {N}_{S} + 1 ] & … & \text{?} [ ( {M}_{f} - 1 ) {N}_{S} + 1 ] \\ ⋮ & ⋮ & ⋱ & ⋮ \\ \text{?} [ {N}_{W} - 1 ] & \text{?} [ {N}_{S} + {N}_{W} - 1 ] & … & \text{?} [ ( {M}_{f} - 1 ) {N}_{S} + {N}_{W} - 1 ]\end{matrix} ] \text{:} {N}_{W} \times {M}_{f} \\ {z}_{i , C , W} = {w}_{a} . \times {z}_{i , C 2} & Equation ( 10 ) \\ \text{?} = [ \begin{matrix}{0}_{{N}_{W} \times 1} \\ \text{?} \\ {0}_{( ( {M}_{f} - 1 ) {N}_{S} - {L}_{1} - {N}_{W} ) \times 1} \\ {0}_{{N}_{W} \times 1}\end{matrix} ] \text{:} ( ( {M}_{f} - 1 ) {N}_{S} + {N}_{W} ) \times 1 \\ \text{?} [ n , m ] = \text{?} [ {mN}_{S} + n ] \\ 1 \leq i \leq {N}_{ERB} , 0 \leq m \leq {M}_{f} - 1 , \\ 0 \leq n \leq {N}_{W} - 1 \\ {z}_{i , E , W} = {w}_{a} . \times {z}_{i , E 2} \\ \text{?} \text{indicates text missing or illegible when filed} & Equation ( 11 )\end{matrix}$$

As shown in Equation (12) below, Z_{i,C,W} and Z_{i,E,W} correspond to the FFT of z_{i,C,W} and Z_{i,E,W}.

Z_{i,C,W}=FFT(z_{i,C,W})

Z_{i,E,W}=FFT(z_{i,E,W}) Equation (12)

Referring to FIG. 2, the signal, for example, z_{i,CS}[n] output from the signal separator 230 is a speech signal estimation output from the i^{th} gammatone filter 220 of the clean speech signal (clean speech). Further, the signals, for example, z_{i,ES}[n] and z_{i,EE}[n] output from the signal separator 230 are the speech estimation and the echo estimation in the i^{th} gammatone filter output of the signal (speech plus echo) in which the speech signal and the echo signal which have passed through the echo canceller are mixed, respectively. The estimations may be acquired by applying binary masks (e.g., H_{i,S}[k,m] and H_{i,E}[k,m] to z_{i,C}[n] and z_{i,EE}[n].

The signals, for example, z_{i,CS}[n], z_{i,ES}[n], and z_{i,EE}[n] are input into the performance evaluator 240, and signal quality may be predicted by using Z_{i,CS}[n], z_{i,ES}[n], and z_{i,EE}[n] input into the performance evaluator 240. The performance evaluator 240 may predict speech signal quality (e.g., speech opinion score: S-MOS), echo signal quality (e.g., echo opinion score: E-MOS), and total signal quality (full name) through the input signals z_{i,CS}[n], z_{i,ES}[n], and z_{i,EE}[n]. Q_{S} related to S-MOS in a case of a double talk is acquired by calculating a correlation between z_{i,ES}[n] corresponding to a speech estimation part of z_{i,E}[n] and z_{i,CS}[n] corresponding to a speech estimation part of z_{l,c}[n] obtained by the signal separator 130, reflecting a weight, and adding all results generated for all values of i. Further, an estimation of Q_{S} is acquired by calculating a correlation between RGT(i)(S+E, EC) and {RGT(i)(CS)+βGT(i)(Eresid)} and adding all results generated for all values of i. High Q_{S} is related to high S-MOS, and a relation between Q_{S} and S-MOS may be indicated by Equation (13) below.

$${Q}_{S} = \text{?} w [ i ] correlation ( \text{?} , \text{?} ) , \\ Where \\ w [ i ] = \frac{\text{?} {( \text{?} [ n ] )}^{2}}{\text{?} \text{?} {( \text{?} [ n ] )}^{2}} , \\ \text{?} = [ \begin{matrix}\text{?} [ 0 ] \\ \text{?} [ 1 ] \\ ⋮ \\ \text{?} [ {L}_{1} - 1 ]\end{matrix} ] , \\ \text{?} = [ \begin{matrix}\text{?} [ 0 ] \\ \text{?} [ 1 ] \\ ⋮ \\ \text{?} [ {L}_{1} - 1 ]\end{matrix} ] , 1 \leq i \leq \text{?} \\ \text{?} \text{indicates text missing or illegible when filed} \qquad Equation ( 13 )$$

Q_{E} related to E-MOS for preventing the user from hearing the user's own fed back voice corresponds to a level in which the echo signal can be recognized. For example, Q_{E} is used as an estimation of E-MOS. z_{i,EE}[n] output from the signal separator 230 is an echo signal estimation part of z_{i,E}[n] acquired by the signal separator 230, and a relation between Q_{E} and E-MOS may be expressed by Equation (14) below. Q_{E} as described above corresponds to an estimation for a degree in which a level of the echo signal is clear, is calculated by (as) GT(i)(Eresid)/RGT(i)(S+E, EC), and is lowered through adding for all i values. Low Q_{E} is related to high E-MOS.

$${Q}_{E} = \frac{1}{{N}_{ERB}} \text{?} \text{?} {( {z}_{i , EE} [ n ] )}^{2} \\ \text{?} \text{indicates text missing or illegible when filed} \qquad Equation ( 14 )$$

Q_{G} may be calculated using Q_{S} and Q_{E} as shown in Equation (15) below.

$${Q}_{G} = \sqrt{\text{?} \times \text{?}} \\ \text{?} \text{indicates text missing or illegible when filed} \qquad Equation ( 15 )$$

In Equation (15), Q_{G} may be converted to General Mean Opinion Score (G-MOS) having a range from 1 to 5. A high G-MOS means that general sound quality in a call felt by the user is good.

FIGS. 4A and 4B illustrate an example of masks corresponding to the speech signal and the echo signal according to an embodiment of the present disclosure.

FIG. 4A illustrates an example of a threshold and a mask applied to the speech signal according to the embodiment of the present disclosure, and FIG. 4B illustrates an example of a threshold and a mask applied to the echo signal according to the embodiment of the present disclosure.

Referring to FIGS. 4A and 4B, sizes of the threshold δS applied to the speech signal and the threshold δE applied to the echo signal may be variably controlled, and masks may be generated in the unit of frames. Referring to FIGS. 4A and 4B, colored blocks are set to “0”, and non-colored blocks are set to “1”. The speech signal input through the mask may be separated into the original signal and the speech signal.

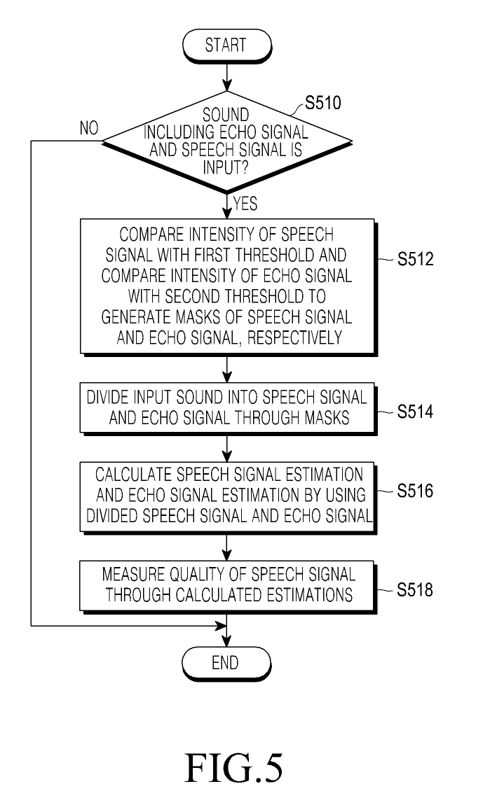

FIG. 5 is a flowchart illustrating a method of measuring quality of a speech signal according to an embodiment of the present disclosure.

Referring to FIG. 5, at operation S510, the electronic device 100 determines whether sound including an echo signal and a speech signal is input.

If the electronic device 100 determines that a sound including an echo signal and a speech signal is not input at operation S510, then the electronic device 100 may proceed to end the method.

In contrast, when the electronic device 100 determines that the speech signal including the echo signal and the original signal is input at operation S510, the electronic device 100 proceeds to operation S512 at which an intensity of the original signal is compared with a first threshold and an intensity of the echo signal is compared with a second threshold, and thus a mask of the original signal and a mask of the echo signal are generated. For example, z_{i,S}[n](1≦i≦NERB, 0≦n≦L1−1) is calculated through Equation (16) by passing the signal xₛ[n] input into the ear model 210 through the ear model 210 and the gammatone filter 220.

z_{i,S}[n]=gᵢ(h_{OM}[n]*x_{S}[n]), 1≦i≦N_{ERB}, 0≦n≦L₁−1 Equation (16)

Further, zi,_{S}[n] is divided into Mf frames by using windows and then reconfigured as a (NW×Mf) matrix. A window size is NW=2048, an overlap rate is r=0.25, a new window sample is NS=rNW=512, and the number of frames is Mf=[LI/NS]+1. z_{i,S} input into the signal separator 230 may be defined as a vector including z_{i,S}[n] (n is a value from 0 to L1−1). z_{i,S} is calculated through Equation (17) below.

$$\text{?} = [ \begin{matrix}\text{?} [ 0 ] & \text{?} [ {N}_{S} ] & … & \text{?} [ ( {M}_{f} - 1 ) {N}_{S} ] \\ \text{?} [ 1 ] & \text{?} [ {N}_{S} + 1 ] & … & \text{?} [ ( {M}_{f} - 1 ) {N}_{S} + 1 ] \\ ⋮ & ⋮ & ⋱ & ⋮ \\ \text{?} [ {N}_{W} - 1 ] & \text{?} [ {N}_{S} + {N}_{W} - 1 ] & … & \text{?} [ ( {M}_{f} - 1 ) {N}_{S} + {N}_{W} - 1 ]\end{matrix} ] \text{:} {N}_{W} \times {M}_{f} \\ \text{?} \text{indicates text missing or illegible when filed} \qquad Equation ( 17 )$$

Further, as shown in Equation (18), z_{i,S,W} (1≦i≦NERB) is calculated and then converted to Z_{i,S,W} by using zₒ₂ calculated through Equation (17) above and Hanning window w(NW×Mf).

$${w}_{s} = [ \begin{matrix}{w}_{s} [ 0 ] & … & {w}_{s} [ 0 ] \\ ⋮ & ⋱ & ⋮ \\ {w}_{s} [ {N}_{W} - 1 ] & … & {w}_{s} [ {N}_{W} - 1 ]\end{matrix} ] \text{:} {N}_{W} \times {M}_{f} \\ {z}_{i , S , W} = {w}_{a} . \times {z}_{i , S 2} \qquad Equation ( 18 )$$

Then, the speech signal mask H_{i,S}[k,m] and the echo signal mask H_{i,E}[k,m] are generated through Equation (19) below by comparing |Z_{i,S,W}[k,m]| with the thresholds δS and δE.

δ_{S}=1.20, δE=0.12, 1≦i≦N_{ERB}, 0≦m≦M_{f}−1, and 0≦k≦N_{W}−1,

|Z_{i,S,W}[k,m]|≧δ_{S}0| [symbol] H_{i,S}[k,m]=1, Z_{i,S,W}[k,m]|<δ_{S}0 [symbol] H_{i,S}[k,m]=0

|Z_{i,S,W}[k,m]|≧δ_{E}0| [symbol] H_{i,E}[k,m]=0, Z_{i,S,W}[k,m]|<δ_{E}0 [symbol] H_{i,E}[k,m]=1 Equation (19)

At operation S514, the input speech signal is separated into the speech signal and the echo signal through each of the generated masks. After the speech and echo components are separated by passing the clean speech signal Z_{i,C,W}[k,m] and the signal Z_{i,E,W}[k,m] in which the speech and the echo are mixed through the speech signal mask and the echo signal mask, z_{i,CS}, z_{i,ES}, and z_{i,EE} are calculated by using IFFT as shown in Equation (20) below.

Z_{i,CS2}[k,m]=H_{i,S}[k,m]Z_{i,C,W}[k,m]

Z_{i,EE2}[k,m]=H_{i,E}[k,m]Z_{i,E,W}[k,m]

z_{i,CS2}=IFFT(Z_{i,CS2})

z_{i,ES2}=IFFT(Z_{i,ES2})

z_{i,EE2}=IFFT(Z_{i,EE2}) Equation (20)

At operation 5516, speech signal estimation and an echo signal estimation are calculated by using the separated speech signal and echo signal. The performance evaluator 240 receives z_{i,CS}, z_{i,ES}, and Z_{i,EE} calculated by the signal separator 230 to calculate S-MOS, E-MOS, and G-MOS. z_{i,CS}[n] is a speech component acquired by passing a near-end user's speech signal transmitted to a far-end user through the speech signal mask, z_{i,ES}[n] is a speech component acquired by passing a user's speech signal+echo signal transmitted to the far-end user through the speech signal mask, and z_{i,CS}[n] is an echo component acquired by passing the user's speech signal+echo signal transmitted to the far-end user through the echo signal mask.

S-MOS(Q_{S}) has a high score as the speech component z_{i,ES}[n] having passed through the echo canceller is similar to the speech signal z_{i,CS}[n] having no echo component by analyzing a correlation between z_{i,CS}[n] and z_{i,ES}[n] as shown in Equation (21) below. At this time, a weight for each section of the frequency domain is applied, and the calculated S-MOS Q_{S} has a value between 0 and 1.

$${Q}_{s} = \text{?} w [ i ] corr ( {z}_{i , CS} , {z}_{i , ES} ) \\ \text{?} \text{indicates text missing or illegible when filed} \qquad Equation ( 21 )$$

### In Equation (21),

$$w [ i ] = \frac{\text{?} {( \text{?} [ n ] )}^{2}}{\text{?} \text{?} {( \text{?} [ n ] )}^{2}} , \\ {z}_{i , CS} = [ \begin{matrix}\text{?} [ 0 ] \\ \text{?} [ 1 ] \\ ⋮ \\ \text{?} [ {L}_{1} - 1 ]\end{matrix} ] , \\ and$$

$$\text{?} = [ \begin{matrix}\text{?} [ 0 ] \\ \text{?} [ 1 ] \\ ⋮ \\ \text{?} [ {L}_{1} - 1 ]\end{matrix} ] . \\ \text{?} \text{indicates text missing or illegible when filed}$$

E-MOS(Q_{E}) is acquired by calculating an energy of an echo signal component z_{i,EE}[n] which has been left after passing through the echo canceller by using Equation (22). The calculated E-MOS Q_{E} has a value between 0 and 1.

$${Q}_{s} = \frac{1}{{N}_{ERB}} \text{?} \text{?} {( {z}_{i , EE} [ n ] )}^{2} \\ \text{?} \text{indicates text missing or illegible when filed} \qquad Equation ( 22 )$$

At operation S518, quality of the speech signal is measured through each of the calculated estimations.

It may be appreciated that various embodiments of the present disclosure can be implemented in the type of hardware, software, or a combination of the hardware and the software. Any such software may be stored, for example, in a volatile or non-volatile storage device such as a ROM, a memory such as a RAM, a memory chip, a memory device, or an Integrated Circuit (IC), or a recordable optical or magnetic machine (for example, computer)-readable storage medium such as a Compact Disk (CD), a Digital Versatile Disk (DVD), a magnetic disk, or a magnetic tape regardless of its ability to be erased or its ability to be re-recorded. For example, software may be stored in a non-transitory storage medium (e.g., a non-transitory computer-readable storage medium). It is appreciated that the storage unit included in the electronic device is one example of a program including commands for implementing various embodiments of the present disclosure or a non-transitory machine-readable storage medium suitable for storing programs. Accordingly, the present disclosure includes a program including a code for implementing an apparatus and a method stated in the claims of the specification and a non-transitory machine (computer)-readable storage medium storing the program. Further, the program may be electronically transported through an arbitrary medium such as a communication signal transmitted through a wired or wireless connection and the present disclosure properly includes the equivalents thereof.

Further, the electronic device may receive the program from a program providing apparatus connected to the electronic device wirelessly or through a wire and store the received program. The program providing apparatus may include a memory for storing a program containing instructions for allowing the electronic device to perform the method of measuring the quality of the speech signal and information required for the method of measuring the quality of the speech signal, a communication unit for performing wired or wireless communication with the electronic device, and a controller for transmitting the corresponding program to the electronic device according to a request of the electronic device or automatically.

While the present disclosure has been described with reference to various embodiments thereof, it will be understood by those skilled in the art that various changes in form and details may be made without departing from the spirit and scope of the present disclosure as defined by the appended claims and their equivalents.

What is claimed is:

1. A method of measuring quality of a speech signal, the method comprising:
generating a mask of an echo signal and a mask of a speech signal by comparing the echo signal and the speech signal included in an input sound with respective thresholds;
calculating an estimation of the echo signal and an estimation of the speech signal; and
measuring quality of the input speech signal by using each of the calculated estimation of the echo signal and the calculated estimation of the speech signal.

2. The method of claim 1, further comprising:
separating the input sound into the echo signal and the speech signal by using the generated masks of the echo signal and the speech signal.

3. The method of claim 1, wherein the generating of the mask of the echo signal the mask of the speech signal comprises:
performing a gammatone filtering for the input speech signal;
dividing the gammatone filtered speech signal into a plurality of frames to configure a matrix;
multiplying the configured matrix and the divided plurality of frames;
performing a Fast Fourier Transform (TTF) on a result of the multiplication between the configured matrix and the divided plurality of frames; and
generating the mask of the echo signal and the mask of the speech signal by comparing the transformed value with each of the thresholds.

4. The method of claim 3, further comprising:
passing the echo signal through the generated mask of the echo signal;
passing the speech signal through the generated mask of the speech signal; and
performing an Inverse Fast Fourier Transform (IFFT) for each of the signals which have passed through the mask of the echo signal and the mask of the speech signal.

5. The method of claim 1, wherein the generating of the mask comprises:
determining the input sound as the speech signal when an intensity of the input sound is equal to or larger than a first threshold; and
determining the input sound as a non-speech signal when the intensity of the input sound is smaller than the first threshold.

6. The method of claim 1, wherein the generating of the mask comprises:
determining the input sound as a non-echo signal when an intensity of the input sound is equal to or larger than a second threshold; and
determining the input sound as the echo signal when the intensity of the input sound is smaller than the second threshold.

7. The method of claim 4, wherein the estimation of the echo signal is calculated through an energy of an echo component remaining after passing through an echo canceller.

8. The method of claim 7, wherein the estimation of the echo signal is calculated by an equation of
$$\text{?} = \frac{1}{{N}_{ERB}} \text{?} \text{?} {( {z}_{i , EE} [ n ] )}^{2} , \\ \text{?} \text{indicates text missing or illegible when filed}$$
where N_{ERB} denotes an equivalent rectangular bandwidth, and z_{i,EE}[n] denotes an echo component acquired by passing a signal transmitted to a far-end user through an echo mask, the signal being generated by combining a speech signal and an echo signal of a near-end user.

9. The method of claim 4, wherein the estimation of the speech signal is calculated through a correlation between signals generated by passing the sound and the speech signal through the mask of the speech signal.

10. The method of claim 9, wherein the estimation of the speech signal is calculated by an equation of
$${Q}_{s} = \text{?} w [ i ] corr ( \text{?} , \text{?} ) , \\ w [ i ] = \frac{\text{?} {( \text{?} [ n ] )}^{2}}{\text{?} \text{?} {( \text{?} [ n ] )}^{2}} , \\ where \\ {z}_{i , CS} = [ \begin{matrix}{z}_{i , CS} [ 0 ] \\ {z}_{i , CS} [ 1 ] \\ ⋮ \\ {z}_{i , CS} [ {L}_{1} - 1 ]\end{matrix} ] , \\ \text{?} = [ \begin{matrix}{z}_{i , ES} [ 0 ] \\ {z}_{i , ES} [ 1 ] \\ ⋮ \\ {z}_{i , ES} [ {L}_{1} - 1 ]\end{matrix} ] , \\ and \\ \text{?} \text{indicates text missing or illegible when filed} \qquad$$
z_{i,CS}[n] denotes a speech component acquired by passing a near-end user's speech signal transmitted to a far-end user through a speech signal mask, z_{i,ES}[n] denotes a speech component acquired by passing a signal in which near-end user's speech signal and echo signal transmitted to the far-end user are mixed through the speech signal mask, and NERB denotes an equivalent rectangular bandwidth.

11. An electronic device measuring quality of a speech signal, the electronic device comprising:
a microphone that receives a sound;
a signal separator that compares an echo signal and a speech signal included in the received sound with respective thresholds to generate a mask of the echo signal and a mask of the speech signal, calculates an estimation of the echo signal and an estimation of the speech signal, and measures quality of the received speech signal by using each of the calculated estimation of the echo signal and the calculated estimation of the speech signal.

12. The electronic device of claim 11, wherein the signal separator separates the received speech signal into an echo signal and a speech signal by using the generated mask of the echo signal and the generated mask of the speech signal.

13. The electronic device of claim 11, wherein the signal separator performs a gammatone filtering for the received speech signal, divides the gammatone filtered speech signal into a plurality of frames to configure a matrix, multiplies the configured matrix and the divided plurality of frames, performs a Fast Fourier Transform (FFT) on a result of the multiplication between the configured matrix and the divided plurality of frames, and compares the transformed value with the respective thresholds, so as to generate the mask of the echo signal and the mask of the speech signal.

14. The electronic device of claim 13, wherein the signal separator passes the echo signal and the speech signal through the generated mask of the echo signal and the generated mask of the speech signal, respectively, and performs an Inverse Fast Fourier Transform (IFFT) for each of the signals having passed the masks.

15. The electronic device of claim 11, wherein the generated mask of the speech signal sets a window to “1” when an intensity of the received sound is equal to or larger than a first threshold, and sets the window to “0” when the intensity of the received sound is smaller than the first threshold.

16. The electronic device of claim 11, wherein the generated mask of the echo signal sets a window to “0” when an intensity of the received sound is equal to or larger than a second threshold, and sets the window to “1” when the intensity of the received sound is smaller than the second threshold.

17. The electronic device of claim 14, wherein the estimation of the speech signal is calculated through a correlation between signals generated by passing the sound and the speech signal through the mask of the speech signal.

18. The electronic device of claim 14, wherein the estimation of the echo signal is calculated through an energy of an echo component remaining after passing through an echo canceller.

19. A non-transitory computer-readable storage medium storing instructions that, when executed, cause at least one processor to perform the method of claim 1.
